(19) United States
(12) Patent Application Publication
(10) Pub. No.: US 2014/0096481 A1
(43) Pub. Date: Apr. 10, 2014

(54) APPARATUS AND METHOD FOR TRANSPORTING A COVER

(71) Applicant: BOEWE SYSTEC GmbH, Augsburg (DE)

(72) Inventors: Helmut FOERG, Grossaitingen (DE); Thomas HUBER, Stadtbergen (DE); Reinhard SEILER, Aindling (DE); Josef BATZER, Leitershofen (DE)

(21) Appl. No.: 14/102,854

(22) Filed: Dec. 11, 2013

Related U.S. Application Data
(63) Continuation of application No. PCT/EP2012/062817, filed on Jul. 2, 2012.

(30) Foreign Application Priority Data
Jul. 11, 2011 (DE) 102011078979.0

(51) Int. Cl. B65H 15/00; B43M 3/04

(52) U.S. Cl. CPC B65H 15/00; B43M 3/045
USPC 53/249; 198/402

(57) ABSTRACT

An apparatus for transporting a cover includes an inlet transport, a turning unit for redirecting and turning the cover and an outlet transport, wherein the turning unit, the inlet transport and the outlet transport are arranged such that at least the inlet transport or the outlet transport transports the cover moving through the turning unit.

### CROSS-REFERENCE TO RELATED APPLICATIONS

This application is a continuation of copending International Application No. PCT/EP2012/062817, filed Jul. 2, 2012, which is incorporated herein by reference in its entirety, and additionally claims priority from German Application No. 102011078979.0, filed Jul. 11, 2011, which is also incorporated herein by reference in its entirety.

### BACKGROUND OF THE INVENTION

The present invention relates to the field of introducing goods into covers, for example introducing one or several goods items into an envelope, and here particularly to an approach for transporting a cover to an inserter, to a cover transport as well as to an inserter.

In the art, several approaches are known for introducing one or several goods items into an envelope. One approach operates in start/stop operation, where the envelopes and the goods to be introduced are moved in a clocked manner, wherein the envelope waits at a filling station so that the goods item can be introduced into the waiting envelope. Other approaches operate continuously so that both the goods item and the envelope are moved along a filling path during the filling process, wherein, at the end of the inserting path, the goods item is introduced into the envelope.

In all these approaches it is necessitated to provide an envelope to the inserter by an envelope applier or an envelope magazine such that the envelope is provided, at the beginning of the filling process, with the desired orientation at the filling position or at the beginning of the filling path. The desired orientation of the envelope can be such that an envelope front where the envelope flap is arranged is directed towards the bottom, so that a goods item to be introduced can be moved over the envelope flap when being introduced into the envelope.

Known inserters comprise, for example, one or several envelope magazines above the filling position, from which the envelopes are drawn and moved to the filling position, which might necessitate turning the envelope to obtain the desired orientation of the envelope at the filling position. Such inserters are described, for example, in U.S. Pat. No. 5,251,425 A, EP 2 189 297 A1 or WO 03/061988 A1. In other inserters, the envelope magazine is arranged below the filling position, as is described, for example, in U.S. Pat. No. 3,423,900 A or U.S. Pat. No. 4,020,615 A. In these inserters, the envelopes are supplied without necessitating a change of the transport direction, however, the envelope magazine is difficult to access, so that refilling envelopes is complex and difficult for an operator.

For avoiding this problem, in other inserters an envelope magazine is arranged beside the inserter, for example in an orientation perpendicular to the extension direction of the inserter at a position easily accessible for an operating person, so that the problems with respect to operation, in particular with respect to providing a sufficient number of envelopes, are avoided.

However, this has the effect that the envelopes are supplied from a direction unequal to the direction in which a filled envelope is output by the inserter. EP 1 473 173 A1 or WO 2010/027521 A1 describe such approaches, wherein EP 1 473 173 A1 necessitates an additional worm transport to move the envelopes from the envelope transport level to the filling level, reducing the obtainable throughput. WO 2010/027521 A1 necessitates an orientation of the output direction towards the top, so that redirection of the filled envelope is necessitated. Other approaches, for example described in USA 2003/0150194 A1 or DE 102 36 497 A1 effect redirection of the envelopes from a first transport direction, where the envelopes are drawn from the magazine, to a second transport direction for feeding to the inserter, necessitating, for example, redirecting by 90°. US 2003/0150194 A1 solves this by a complex and error-prone curve transport. Inserters similar to the one described in DE 102 36 497 A1 have the effect that an envelope drawn from a magazine is moved in a first transport direction through a first transport to a stop and taken over by a second transport effecting further transport of the envelope at 90° to the original direction to the inserter. Possibly, turning the envelope is also necessitated, so that the same is provided to the inserter with the desired orientation.

Such approaches are particularly disadvantageous in the high-speed range for high-power inserters, since the 90° redirection limits performance. When reaching the 90° redirection, the envelopes are stopped and taken over by a new transport. By the start/stop operation, high forces act on the envelope, resulting in additional stresses for the envelope. Further, there is the risk of damaging an envelope, for example at the edge impinging on the stop in the redirection, whereby in the subsequent inserting process problems can occur due to erroneous insertions or jams. Further, such approaches necessitate complex conversion of the transports when the format is changed, since an envelope is, for example, initially moved in the direction of the edges perpendicular to the envelope opening but is moved further from the redirection position in a direction parallel to these edges. The possibly necessitated turning necessitates an additional element, which takes up additional time and holds the risk of damages or problems when transporting the envelope, which can have a negative influence on the throughput.

### SUMMARY

According to an embodiment, an apparatus for transporting a cover may have: a cover inlet transport; a cover turning unit for redirecting and turning the cover; and a cover outlet transport; wherein the cover turning unit, the cover inlet transport and the cover outlet transport are arranged such that at least the cover inlet transport or the cover outlet transport transport the cover moving through the cover turning unit, wherein the cover inlet transport is configured to effect transport of the cover in a first transport direction, wherein the cover outlet transport is configured to effect transport of the cover in a second transport direction differing from the first transport direction, wherein the cover turning unit is arranged at an angle to the first transport direction and the second transport direction, and wherein the cover turning unit includes two spaced-apart passive guides for redirecting and turning the cover.

According to another embodiment, a cover transport system may have: a magazine that is configured to receive a plurality of covers; an inventive apparatus, wherein the cover inlet transport is coupled to the magazine to receive covers provided by the magazine.

According to another embodiment, an inserter for introducing one or several goods into a cover may have: a goods supply; an inventive cover transport system; and an inserting means for introducing the one or several goods into a cover provided by the cover applying unit.

According to another embodiment, a method for transporting a cover may have the steps of: supplying the cover; redirecting and turning the cover; and outputting the cover; wherein the cover is moved during supplying, redirecting and turning and outputting by maintaining an orientation of the leading edge of the cover with respect to the transport direction of the cover, wherein the cover is transported in a first transport direction during supplying, wherein the cover is transported in a second transport direction differing from the first transport direction during outputting, and wherein the cover is redirected and turned by a cover turning unit which is arranged at an angle to the first transport direction and the second transport direction, wherein the cover turning unit includes two spaced-apart passive guides for redirecting and turning the cover.

The present invention provides an apparatus for transporting a cover, comprising:
an inlet transport;
a turning unit for redirecting and turning the cover; and
an outlet transport;
wherein the turning unit, the inlet transport and the outlet transport are arranged such that at least the inlet transport or the outlet transport transport the cover moving through the turning unit.

The present invention further provides a cover transport system having a magazine that is configured to accommodate a plurality of covers and an apparatus according to embodiments of the invention, wherein the inlet transport is coupled to the magazine in order to receive envelopes provided by the magazine.

The present invention further provides an inserter for introducing one or several goods items into a cover, having a goods supply, a cover transport system according to embodiments of the invention and an inserting means for introducing the one or several goods items into the cover provided by the cover transport system.

The present invention further provides a method for transporting a cover, comprising:
supplying the cover;
redirecting and turning the cover; and
outputting the cover;
wherein the cover is moved, during redirecting and turning and outputting the same, by maintaining an orientation of the edges of the cover with respect to the transport direction of the cover.

Embodiments of the invention comprise a turning unit including a turning tray having an inner tray and an outer tray, between which a gap is provided between which the cover, advantageously an envelope, moves.

Further implementations of the invention are defined in the sub-claims.

The inventive approach is advantageous since the envelope magazine can be arranged at an easy-to-reach position, e.g. beside the inserter, wherein at the same time the problems existing in conventional technology with redirecting and turning of a drawn envelope are avoided. The envelope is moved continuously (without stopping) through the turning unit, simultaneously effecting redirecting and turning of the envelope without having to change its orientation with respect to the transport direction, so that, for example, the envelope is transported in front of the turning unit and behind the turning unit via its broad side (side parallel to the envelope opening). This has, among others, the advantage that lower transport speeds are necessitated with the same throughput compared to a transport via the longitudinal side (side perpendicular to the envelope opening).

A further advantage is that the turning unit effects twisting of the envelope, whereby tensions within the envelope are released and the front and rear sides of the envelope possibly adhering to one another, for example due to adhesive points on the inside of the envelope, are mechanically released. Further, by turning the envelope, the envelope flap is pressed down, so that the same remains in the opened position during further processing or a return to a position overlapping with the envelope body is prevented.

The inventive approach is further independent of the format, i.e. processing is possible without changing the format, independent of the size of the envelope. Damaging the envelope is prevented since no stops exist. Within the turning tray, no actuator is necessitated, however, it is ensured that the envelope is transported at least through one of the inlet or outlet transports so that continuous movement of the envelope is ensured.

In the conventional technology concerning sheet transports, approaches for turning individual sheets are known comprising a turning unit. Exemplarily, reference is made to WO 2011/00738 A1 and U.S. Pat. No. 5,362,039 A. However, these plants serve to turn individual sheets, i.e. one-sheet elements. So far, it has been assumed that for the following reasons processing envelopes through such a unit is not possible. Contrary to individual sheets, covers, for example envelopes, are goods comprising two layers of sheet-like elements connected to one another at several of their edges, wherein one layer possibly includes a window of again another material. Further, envelopes include an envelope flap projecting at one side of the envelope or arranged in an overlapping manner with the envelope. Due to the double-layered structure of an envelope, compared to an individual layer, a higher stiffness results (e.g. in the area of the glued edges, at particular at the corners). Further, the two layers are connected to one another, so that overlying layers are moved during a movement through a turning tray to a different extent due to the different radii (radius effect), which can cause twists or creases due to the connection of the two layers, which does not allow safe transport of such a structure by a turning tray. In particular for large-format envelopes, processing by a turning tray has been considered impossible since in such envelopes the edges additionally comprise a fold to provide sufficient volume for receiving goods. This results in a further increase in stiffness. Further, it has been assumed that envelopes, contrary to sheets, are not suitable for transport through turning units due to their undefined and unfavorable geometry, for example changing flaps or the unfavorable height/width ratio. In particular, the mentioned approaches are intended for processing sheets of the same format (same dimensions) and adjustment of the necessitated transport elements is not provided for. However, inserters operate with different envelope formats whose dimensions can differ by several centimeters so that conventional turning units are not suitable for transporting such envelopes or necessitate complex conversion of the transports. For the above-stated reasons, so far the view has been taken in conventional technology that turning trays as described in the stated documents are not suitable for transporting envelopes.

Extensive examinations and tests of the applicant have led to the finding that such turning units known from sheet transports are basically also suitable for envelope transport systems, in particular for redirecting and turning envelopes, so that according to the teaching of the present invention, for the first time an apparatus is provided which serves to transport covers or envelopes and which enables a turning unit for simultaneously redirecting and turning the cover during a continuous movement of the cover.

### BRIEF DESCRIPTION OF THE DRAWINGS

Embodiments of the present invention will be detailed subsequently referring to the appended drawings, in which:

FIG. 1 shows a basic diagram of an apparatus for transporting a cover according to an embodiment of the invention;

FIG. 2 shows a schematic illustration of an apparatus for transporting a cover according to a further embodiment of the invention;

FIG. 3 shows a side sectional view of the arrangement of FIG. 2;

FIG. 4 shows an apparatus for transporting a cover according to again another embodiment of the invention;

FIG. 5 shows another embodiment of the inventive apparatus;

FIG. 6 shows a cover transport system comprising an apparatus according to embodiments of the invention; and

FIG. 7 shows an inserter comprising the cover transport system described based on FIG. 6.

### DETAILED DESCRIPTION OF THE INVENTION

In the following description of embodiments of the present invention, the same or equal elements are referred to with the same reference numbers in the figures.

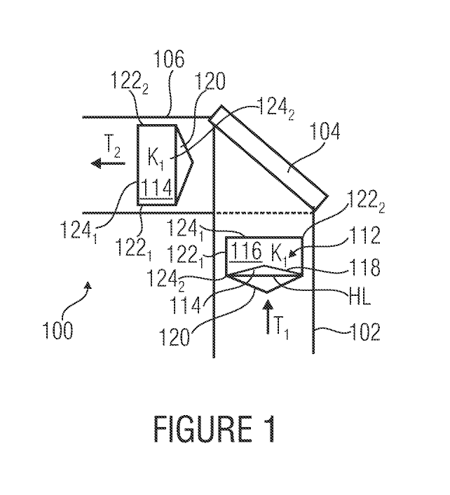

FIG. 1 shows a basic diagram of an apparatus for transporting a cover according to an embodiment of the invention, based on which the envelope supply via a turning tray will be discussed in more detail. The apparatus shown in FIG. 1 is provided with the reference number 100 in its entirety and includes an inlet transport 102 and a turning unit 104 as well as an outlet transport 106. The inlet transport 102, the turning tray 104 and the outlet transport 106 are arranged successively in envelope transport direction.

An envelope K₁ is moved through the inlet transport 102 in the direction of the turning tray 104 along a first transport direction T₁. The envelope K₁ includes an envelope body 112 including an envelope front 114, an envelope rear 116 and an envelope opening 118. The envelope K₁ further includes an envelope flap 120 arranged at the envelope front, wherein the connection region between the envelope flap 120 and the envelope front is referred to as a hinge line (HL). The envelope K₁ includes two parallel longitudinal sides 122₁, 122₂ defined by the parallel edges of the envelope K₁ perpendicular to the hinge line. Furthermore, the envelope K₁ includes two opposing broad sides 124₁, 124₂ defined by the edges perpendicular to the longitudinal sides 122₁, 122₂. The edge 124₁ which leads or is at the front in the transport direction T₁ defines an envelope bottom of the envelope K₁. The edge 124₂ which follows or is at the back in the transport direction T₁ coincides with the hinge line (HL). The transport of the envelope K₁ takes place advantageously in the shown orientation via the broad side with the envelope flap 120 at the back in the transport direction. The envelope K₁ is moved in the direction of the turning tray 104 by means of the inlet transport 102. There, the same experiences a redirection of 90° as well as a turn due to the implementation of the turning tray, so that the envelope front 114 lying at the bottom in the inlet transport 102 is at the top in the outlet transport 106 as is illustrated in FIG. 1. The redirected and turned envelope is moved along the transport direction T₂, wherein the transport direction T₁ and the transport direction T₂ are perpendicular to one another. The turning tray 104 is arranged perpendicular to an angle bisector of the angle spanned by the two transport directions T₁ and T₂. The envelope K₁ is still moved along the broad side even after turning and redirecting, i.e. the orientation of the edges of the envelope in front of and behind the turning tray with respect to the respective transport direction T₁ and T₂ remains unchanged. This means that the broad side 124₁ forms the leading edge both in front of and behind the turning tray in the transport direction. Accordingly, the broad side 124₂ arranged at the hinge line remains the rear edge in the transport direction. The orientation of the longitudinal sides 122₁ and 122₂, each parallel to the respective transport direction T₁ and T₂ is also maintained.

In the embodiment shown in FIG. 1, the turning tray 104 comprises two trays, an inner tray and an outer tray arranged at a distance to one another, between which the envelope is moved. Due to the arrangement of the turning tray, the above-described redirecting and turning is performed such that the envelope supplied at the inlet transport level is arranged, in the manner illustrated in FIG. 1, at the outlet transport level which lies above or below (in FIG. 1 below) the inlet transport level. The turning tray advantageously comprises tray elements that are half-cylinder-shaped in cross-section. The inlet transport or the outlet transport extends up to the respective trays so that an envelope running through the turning tray 104 is moved at least through the inlet transport at the beginning and an already turned and redirected part of the envelope is conveyed by the outlet transport, so that when the envelope is released by the inlet transport, conveyance by the outlet transport, and hence continuous movement is already ensured. The elements of the turning tray are passive elements, i.e. the same are not driven. According to embodiments, it can be intended to provide stationary, i.e. non-moving elements, however it is also possible to implement, for example, the inner turning tray by a pivoted rod, which supports the transport.

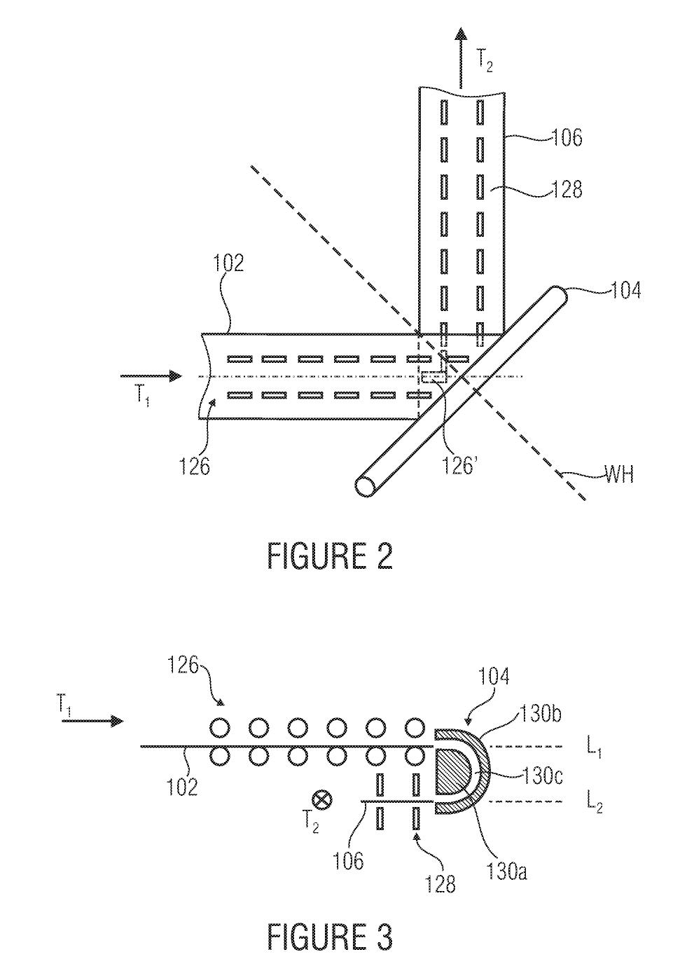

FIG. 2 shows a further schematic illustration of an apparatus according to an embodiment of the invention, wherein elements described based on FIG. 1 are provided with the same reference numbers. FIG. 2 again shows a top view of the arrangement, but without envelopes. In FIG. 2, the angle bisector WH of the angle spanned by the two transport directions T₁ and T₂ is shown, wherein, as mentioned, the turning tray 104 shown schematically in FIG. 2 is arranged orthogonally to the angle bisector WH. The inlet transport 102 includes a roller transport 126 including two parallel rows, each comprising a plurality of individual rollers arranged behind one another in the transport direction T₁. FIG. 2 does not show further rollers above the rollers shown, between which an envelope is moved in the direction of the turning tray 104. The outlet transport 106 also includes a roller transport 128 having two rows of a plurality of rollers arranged in parallel, wherein the rollers arranged above are not shown in FIG. 2. As is shown in FIG. 2, the transports 126 and 128 are implemented to ensure transport of the envelopes up to the turning tray 104, wherein in the shown embodiment, in the inlet transport 102, the width of the transport area defined by the transport 126 decreases in the direction of the turning tray 104. More accurately, one of the transport element rows of the transport 126 includes one transport element less than the top row, so that in each case one transport element is arranged adjacent to the turning tray 104. Here, it should be noted that also other transports can be provided, in particular also several rows of drive elements, wherein the implementation according to FIG. 2 ensures that the envelope is driven until it reaches the turning tray 104. The outlet transport 106 includes a roller transport essentially having the same structure, which ensures that an envelope, when leaving the turning tray 104, is already transported by the outlet transport, so that continuous movement during the redirecting and turning process is ensured. As can be seen in FIG. 2, the inlet transport 102 includes a plurality of transport elements arranged successively, just like the outlet transport 106. The width of the transport 126 decreases in the direction of the turning tray 104, whereas the width of the transport 128 increases starting from the turning tray 104. According to a further embodiment, the inlet and/or the outlet transport can additionally comprise one or several idle rollers, arranged, for example, between the rollers in FIG. 2 (see reference number 126′). The effect of this roller 126′ is to exert a counter-torque on an envelope to avoid shifting or an offset of the portion of the envelope not conveyed by a transport, which can be particularly desirable for small formats. The following table states examples of envelope formats common in Europe, with the respective dimensions used in inserters.

TABLE 1
Examples of envelope formats common in Europe

| FORMAT | Width (mm) | Length (mm) |
|---|---|---|
| C6 | 114 | 162 |
| B6 | 125 | 176 |
| C5/6 (DL) | 110 | 220 |
| C6/5* | 114 | 229 |
| C5 | 162 | 229 |
| B5 | 176 | 250 |
| C4 | 229 | 324 |
| B4 | 250 | 353 |
| E4 | 280 | 400 |
| C3 | 324 | 458 |

*as high as C6 and as wide as C5

Table 1 illustrates the plurality of different envelope formats that are possibly processed by an inserter and pass through a turning tray. Apart from the different dimensions, the envelopes possibly also comprise windows of different sizes at different positions.

Here, it should be noted that the present invention is not limited to the implementation of the inlet and outlet transports as roller transports, but rather the inlet and outlet transports can each comprise a plurality of shafts, wherein the shafts comprise a decreasing width in the direction of the turning tray in order to ensure continuous transport of the envelope to and from the turning tray. Also, belt transports or suction belt transports can be provided. In another embodiment it can be provided that the envelope is transported between continuously running ribbons or cloths moved round the turning tray. Further, it should be noted that also different transport elements can be used in the inlet and outlet transport, such as a combination of rollers and shafts, rollers and belts or shafts and belts.

FIG. 3 shows a lateral sectional view of the arrangement of FIG. 2, where it can be seen that the transport levels L1 and L2 at which the envelopes are input or output are at different heights. FIG. 3 shows the roller transport 126 of the inlet transport 102 which includes, as already mentioned above, rollers above one another for transporting envelopes between the same in the direction of the turning tray 104. The outlet transport 106 includes the roller transport 128 also comprising rollers above one another to transport the redirected and turned envelope. FIG. 3 further shows an implementation of the turning tray 104 comprising an inner tray 130a as well as an outer tray 130b arranged at a distance 130c to one another, so that a passage results between the two trays 130a and 130b, through which an envelope is moved for redirecting and turning, which is obtained by the arrangement of the turning tray as shown in FIG. 2 with respect to the transport direction. FIG. 3 shows the transport levels L1 and L2 as horizontal parallel levels. The present invention is not limited to such an orientation of the transport levels L1 and L2. Rather, the transport levels L1 and L2 can also be arranged in a tilted manner. It can be provided, for example, that the transport levels L1 and L2 are tilted in the direction of the respective transport direction, so that the inlet transport extends, for example, from a position above or below a level where an envelope is inserted into the turning tray towards the top or towards the bottom of the turning tray. The outlet transport can extend from an output of the turning tray to a position above or below the output of the turning tray.

Here, it should further be noted that the present invention is not limited to the above-described turning trays. Rather, turning trays of any design can be used, where the inner and outer elements are realized by respective wire netting. Also, no continuous unit 104 is necessitated, but rather several adjacent units are possible. Likewise, the turning unit 104 can be realized by a rod arrangement or drum arrangement, around which a ribbon or cloth is wound to realize a redirecting and turning process.

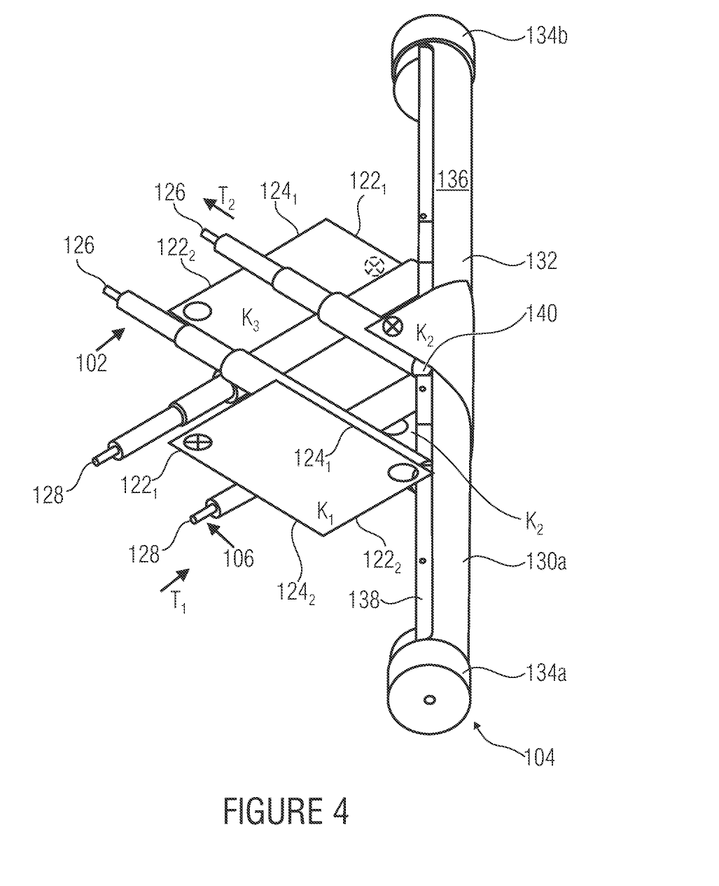

FIG. 4 shows an apparatus according to a further embodiment of the invention. FIG. 4 only shows the inner tray 130a of the turning tray 104. The inner tray 130a comprises a central portion 132 arranged between two end portions 134a, 134b. The central portion 132 can be implemented integrally or in several parts with the end portions 134a and 134b. The central portion 132 includes an outer surface 136 and has a cross-section that is essentially half-cylindrical or half-circular in shape. An envelope to be turned is moved on the surface 136 as is shown in FIG. 4. Further, the central portion 132 includes a projection 138 reset with respect to the surface 136 and comprising a plurality of bearing positions (see reference number 140) to receive one end of the transport element of the inlet each. FIG. 4 merely shows the portion of the central portion 132 shown at the inlet transport level, however the portion lying at the transport outlet level is structured accordingly and includes a respective portion for receiving the transport elements of the outlet transport.

In the embodiment shown in FIG. 4, the inlet transport 102 is formed by transport elements 126 implemented as shaft pairs, wherein the shafts become narrower in the direction of the turning element 104. The outlet transport 106 also includes the shafts 128 which become broader starting from the turning element 104. Further, FIG. 4 shows a first envelope K₁ waiting at the turning tray 104. A second envelope K₂ is shown which is just being moved through the turning tray 104 and an envelope K₃ is shown which is being transported off through the outlet transport 106. As can be seen, the turning tray passes from the transport direction T₁ into the transport direction T₂ for redirecting the envelopes and further for turning the same so that the side of the envelope lying at the top in the inlet transport is the bottom side in the outlet transport (see mark). FIG. 4 shows the turning tray 104 without the outer tray for simplifying the illustration, however, during operation, the outer tray is provided, as shown in FIG. 3, in addition to the inner tray having the arc-shaped surface 136.

The implementation of the transport elements 126 and 128 ensures that the envelopes K₁ to K₃ are conveyed during their movement through the turning tray 104, either by both transports or at least by one of the transports. Further, the implementation according to FIG. 4 is advantageous, since here, due to the continuous shafts, transport, redirecting and turning of any envelope formats is possible without adjustment of the transport, for example a distance of transport elements or the like, being necessitated.

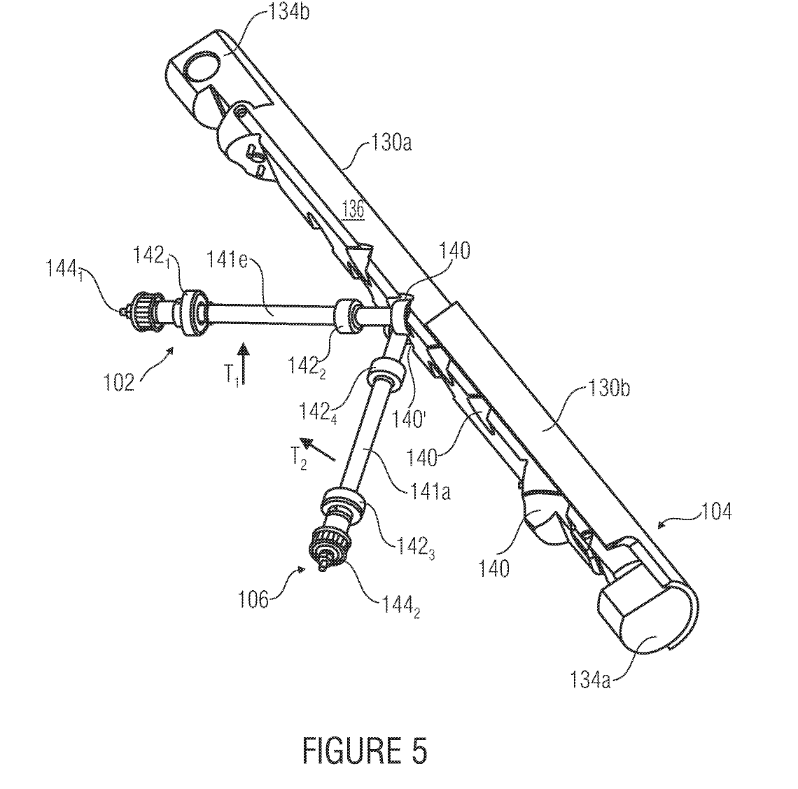

FIG. 5 again shows a further embodiment of the inventive apparatus where the turning tray 104 is structured similarly to FIG. 4 with respect to its inner tray. The transport elements 126 and 128 of the inlet and outlet transports 102, 106 are different from FIG. 4 in that they are formed by roller transports, wherein the roller transport comprises two adjacent rollers, 142₁-142₄ arranged on a common shaft 141_{c}, 141ₐ. For a better illustration, FIG. 5 shows only one shaft of the inlet or outlet transport in each case, however a plurality of respective shafts are provided arranged with one end in each of the bearings 140. Each of the shafts 141ₑ, 141ₐ comprises a drive wheel 144₁, 144₂ to be driven, for example, via a belt or a gear. The ends opposing the drive wheel 144₁, 144₂ are pivoted in the bearings or recesses 140, 140′ of the turning tray 104. In the example shown in FIG. 5, further the outer tray 130b is shown extending only via a part of the inner tray 130a, advantageously from one end 134a to approximately the center of the tray 104. It has been shown that the outer tray 130b arranged only above part of the turning tray is advantageous and sufficient to reliably enable the desired redirecting and turning process of an envelope, wherein the simultaneous effect is that during transport of the envelope, oriented to the center of the inlet transport, the edge of an envelope (edge 122₁ in FIG. 4) arranged apart with respect to the turning tray is free during the turning process, whereas the adjacent edge 122₂ and edges 124₁ and 124₂ are conveyed at least partly between the inner tray 130a and the outer tray 130b. Tests of the applicant have shown that by this implementation of the turning tray also reliable redirecting and turning of the envelope can be obtained, wherein simultaneously the transport is improved since excessive twisting of the envelope and hence possible problems during transport through the turning tray are reduced, since part of the envelope is free.

Embodiments of the invention have been described based on arrangements that serve to redirect and turn envelopes. Here, it should be noted that the inventive approach is not limited to envelopes, but is generally also suitable for covers without flaps.

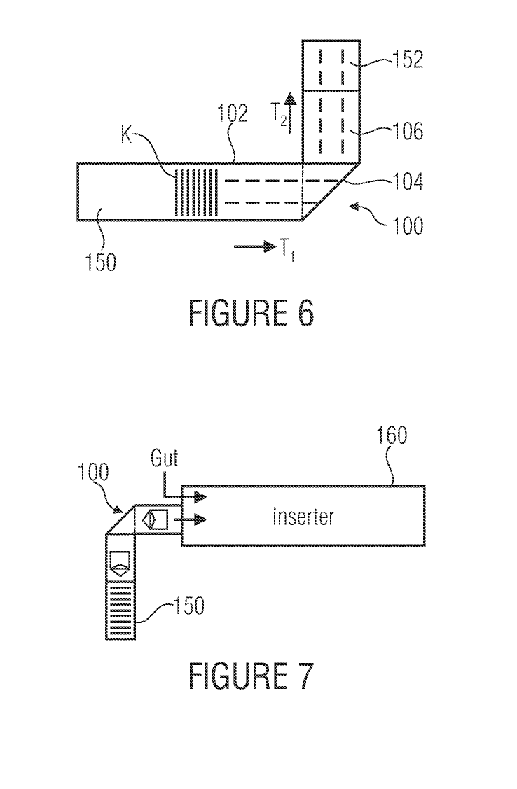

FIG. 6 shows a cover transport system comprising the inventive apparatus. FIG. 6 shows a magazine 150 intended for receiving a plurality of envelopes. In the embodiment shown in FIG. 6, the magazine 150 is provided to receive envelopes (or covers) in a standing manner. The envelopes are advantageously arranged in the magazine 150 with the hinge line towards the top and the opening in the transport direction T₁. The magazine 150 includes an outlet not shown in more detail in FIG. 6 to withdraw individual envelopes from the magazine 150 and supply the same to the inlet transport 102 of the inventive apparatus 100. The apparatus 100 effects the transport of the withdrawn envelope in the transport direction T₁, redirecting the same in the transport direction T₂ while simultaneously turning the same by the turning unit 104, and further transport through the outlet transport 106. Further, the system can comprise a cover transport 152 in order to supply the envelope withdrawn from the magazine 100, redirected and turned to a further processing station. The system is implemented such that the inlet transport 102 is coupled to the magazine 150, and such that the transport 152 is coupled to the outlet transport 106 of the apparatus 100, whereby continuous movement of the withdrawn envelope through the apparatus 100 and through the transport 152 is ensured without stopping.

FIG. 7 shows an inserter 160 comprising the cover transport system described based on FIG. 6 in order to provide, together with the goods, whose supply is schematically shown in FIG. 7, covers or envelopes from the magazine 150 via the inventive apparatus with the desired orientation in order to thus arrange envelopes for filling with the goods in the inserter 160 and to output filled goods. The inserter is implemented such that the goods item as well as the envelopes are continuously moved after withdrawal from the magazine 150. Introducing the goods into the provided envelopes and outputting the filled envelopes for further processing is performed in the inserter 160.

While some aspects have been described in the context of an apparatus, it is obvious that these aspects also represent a description of the respective method, so that a block or a device of an apparatus can also be seen as a respective method step or feature of a method step. Analogously, aspects described in the context of one or as a method step also represent a description of a respective block or detail or feature of a respective apparatus.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Apparatus for transporting a cover, comprising:
a cover inlet transport;
a cover turning unit for redirecting and turning the cover; and
a cover outlet transport;
wherein the cover turning unit, the cover inlet transport and the cover outlet transport are arranged such that at least the cover inlet transport or the cover outlet transport transport the cover moving through the cover turning unit,
wherein the cover inlet transport is configured to effect transport of the cover in a first transport direction,
wherein the cover outlet transport is configured to effect transport of the cover in a second transport direction differing from the first transport direction,
wherein the cover turning unit is arranged at an angle to the first transport direction and the second transport direction, and
wherein the cover turning unit comprises two spaced-apart passive guides for redirecting and turning the cover.

2. Apparatus according to claim 1, wherein the cover inlet transport and the cover outlet transport are configured to effect continuous transport of the cover.

3. Apparatus according to claims 1, wherein the first and second transport directions are arranged at an angle to each other, and wherein the turning unit is arranged orthogonally to an angle bisector of the angle between the transport directions.

4. Apparatus according to claim 1, wherein the cover inlet transport comprises a width decreasing in the direction of the cover turning unit and the cover outlet transport comprises a width increasing in the direction away from the cover turning unit.

5. Apparatus according to claim 4, wherein the cover inlet transport comprises a plurality of transport elements arranged successively in the first transport direction, and the cover outlet transport comprises a plurality of transport elements arranged successively in the second transport direction.

6. Apparatus according to claim 1, wherein the transport elements each comprise one or several shafts, rollers, belts or suction belts arranged transversely to the transport direction.

7. Apparatus according to claim 1, wherein the cover turning unit comprises a turning tray comprising an inner tray and an outer tray spaced apart from the inner tray.

8. Apparatus according to claim 7, wherein the outer tray extends only across part of the width of the turning tray.

9. Apparatus according to claim 7, wherein the inner and outer trays each comprise an arc-shaped surface.

10. Apparatus according to claim 1, wherein the cover comprises an envelope with an envelope flap.

11. Cover transport system, comprising:
a magazine that is configured to receive a plurality of covers;
an apparatus according to claim 1, wherein the cover inlet transport is coupled to the magazine to receive covers provided by the magazine.

12. Cover transport system according to claim 11 with a cover transport for supplying the covers to a subsequent processing station, wherein the cover transport is coupled to the cover outlet transport of the apparatus to receive a turned cover, and wherein the cover inlet transport, the cover outlet transport and the cover transport are configured to effect continuous transport of the cover.

13. Inserter for introducing one or several goods into a cover, comprising
a goods supply;
a cover transport system according to claim 11; and
an inserting unit for introducing the one or several goods into a cover provided by the cover applying unit.

14. Inserter according to claim 13, wherein the cover transport, the cover inlet transport, the cover outlet transport and the inserting unit effect continuous transport of the cover.

15. Method for transporting a cover, comprising:
supplying the cover;
redirecting and turning the cover; and
outputting the cover;
wherein the cover is moved during supplying, redirecting and turning and outputting by maintaining an orientation of the leading edge of the cover with respect to the transport direction of the cover,
wherein the cover is transported in a first transport direction during supplying,
wherein the cover is transported in a second transport direction differing from the first transport direction during outputting, and
wherein the cover is redirected and turned by a cover turning unit which is arranged at an angle to the first transport direction and the second transport direction, wherein the cover turning unit comprises two spaced-apart passive guides for redirecting and turning the cover.

16. Method according to claim 15, wherein the cover is moved continuously.

17. Method according to claim 15, wherein the cover is supplied in a first transport direction and redirected and output in a second transport direction, wherein an edge of the cover leading with respect to the first transport direction and an edge of the cover leading with respect to the second transport direction are equal.

18. Method according to claim 17, wherein the leading edge of the cover is oriented perpendicular to the transport direction of the cover.
